(19) United States
(12) Patent Application Publication
(10) Pub. No.: US 2008/0062957 A1
(43) Pub. Date: Mar. 13, 2008

(54) Method and apparatus for aligned transmissions in a wireless network

(75) Inventors: Murali Narasimha, Lake Zurich, IL (US); Harald van Kampen, Nieuwegein (NL)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Motorola, Inc., Schaumburg, IL (US)

(21) Appl. No.: 11/519,236

(22) Filed: Sep. 11, 2006

(51) Int. Cl. H04J 3/06

(52) U.S. Cl. 370/350

(57) ABSTRACT

A first adjustment range of a first scheduled occurrence of a first transmission event associated with a first data service is determined based on a first transmission interval of the first data service and a non-zero first interval adjustment tolerance. A second adjustment range of a second scheduled occurrence of a second transmission event associated with a second data service is determined based on a second transmission interval of the second data service and a second interval adjustment tolerance. An activation period is determined at a wireless device based on an alignment of the first transmission event and the second transmission event in response to the first adjustment range and the second adjustment range being concurrent and the wireless device activates a wireless interface for the activation period.

### FIELD OF THE DISCLOSURE

The present disclosure relates generally to wireless networks and more particularly to scheduling transmissions in wireless networks.

### BACKGROUND

Wireless networks often employ some form of transmission scheduling so as to reduce the amount of time the wireless transceivers of portable devices are activated, thereby reducing power consumption by the portable devices. Typically, each service of the wireless network has a transmission interval used to schedule successive transmissions for service. Two or more devices of the wireless network concurrently activate their wireless transceivers at the elapse of each transmission interval for the purposes of transmitting or receiving data associated with the service amongst the two or more devices. In between the transmission intervals, wireless devices operating with a relatively limited power supply (e.g., a battery power supply) may maintain their wireless transceivers in an inoperative state, thereby reducing power consumption between transmission intervals. Thus, in wireless networks whereby only a single service is supported, the transmission interval scheduling process can provide power savings. However, in wireless networks whereby a plurality of services are supported by a wireless device, each service may have a different transmission interval. Activating a transceiver for each service's transmission interval increases the frequency at which the wireless transceiver is activated for the wireless device, and thereby reduces the power savings benefit. Accordingly, an improved technique for scheduling transmissions in a wireless network would be advantageous.

### BRIEF DESCRIPTION OF THE DRAWINGS

The present disclosure may be better understood and its numerous features and advantages made apparent to those skilled in the art by referencing the accompanying drawings.

FIG. 1 is a diagram illustrating a wireless network including a plurality of wireless devices in accordance with at least one embodiment of the present disclosure.

FIG. 2 is a flow diagram illustrating a method for providing an indicator of an interval adjustment tolerance for a data service from one wireless device to another wireless device in accordance with at least one embodiment of the present disclosure.

FIG. 3 is a timing diagram illustrating examples of transmission event schedules in accordance with at least one embodiment of the present disclosure.

FIG. 4 is a flow diagram illustrating a method for implementing a received indicator of an interval adjustment tolerance for a data service in accordance with at least one embodiment of the present disclosure.

FIG. 5 is a flow diagram illustrating a method for aligning transmission events of a plurality of data services based on the transmission intervals and interval adjustment tolerances associated with the data services in accordance with at least one embodiment of the present disclosure.

The use of the same reference symbols in different drawings indicates similar or identical items.

### DETAILED DESCRIPTION

In accordance with one aspect of the present disclosure, a first scheduled occurrence of a first transmission event associated with a first data service is determined at a first wireless device based on a first transmission interval associated with the first data service. A second scheduled occurrence of a second transmission associated with a second data service event is determined at the wireless device based on a second transmission interval associated with the second data service. The first wireless device adjusts the first scheduled occurrence of the first transmission event to align the first transmission event with the second transmission event in response to determining that the second scheduled occurrence is within a non-zero first interval adjustment tolerance of the first scheduled occurrence. The first interval adjustment tolerance is associated with the first data service. The first wireless device activates a wireless interface of the wireless device for an activation period concurrent with the second scheduled occurrence for conducting the first transmission event and the second transmission event in response to adjusting the first scheduled occurrence.

In accordance with another aspect of the present disclosure, a first adjustment range of a first scheduled occurrence of a first transmission event associated with a first data service is determined based on a first transmission interval of the first data service and a non-zero first interval adjustment tolerance. A second adjustment range of a second scheduled occurrence of a second transmission event associated with a second data service is determined based on a second transmission interval of the second data service and a second interval adjustment tolerance. An activation period is determined at a wireless device based on an alignment of the first transmission event and the second transmission event in response to the first adjustment range and the second adjustment range being concurrent and the wireless device activates a wireless interface for the activation period.

In accordance with yet another aspect of the present disclosure, a transmission interval associated with a data service and a non-zero interval adjustment tolerance for the transmission interval are determined and an indicator of the interval adjustment tolerance is transmitted from a first wireless device for reception by a second wireless device.

In accordance with an additional aspect of the present disclosure, a device includes a wireless interface, a processing device coupled to the wireless interface, and a memory coupled to the processing device. The memory is configured to store a set of instructions configured to manipulate the processing device to determine a first adjustment range of a first scheduled occurrence of a first transmission event associated with a first data service based on a first transmission interval of the first data service and a non-zero first interval adjustment tolerance. The set of instructions further is configured to determine a second adjustment range of a second scheduled occurrence of a second transmission event associated with a second data service based on a second transmission interval of the second data service and a second interval adjustment tolerance. The set of instructions further is configured to determine an alignment of the first transmission event and the second transmission event in response to the first adjustment range and the second adjustment range being concurrent and to activate the wireless interface for an activation period based on the alignment of the first transmission event and the second transmission event.

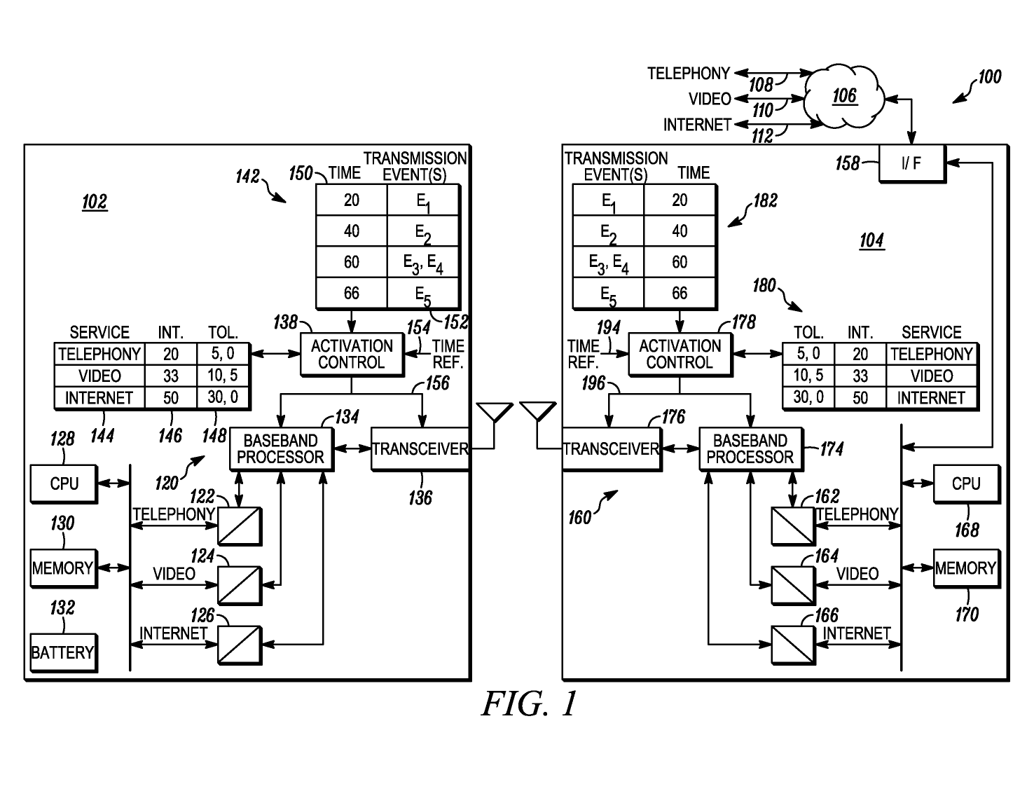

FIGS. 1-5 illustrate techniques for scheduling transmission events for data services in a wireless network in accordance with at least one embodiment of the present disclosure. Each data service includes a corresponding transmission interval for which transmission events for the data service can be scheduled to occur. Some or all of the data services also include a corresponding interval adjustment tolerance indicating a limit to the amount by which a scheduled occurrence of a transmission event for the data service can be delayed, or alternately advanced, for the purposes of aligning transmission events. Both the transmitting wireless device and the receiving wireless device for a transmission event individually determine the scheduled occurrence of the transmission event and further individually determine whether the scheduled occurrence of the transmission event can be adjusted, subject to the associated interval adjustment tolerance, so as to occur during the same wireless interface activation period as the scheduled occurrences of other transmission events of other data services of the same service type (e.g., an uplink transmission event and a downlink transmission event) or for different service types, or a combination thereof. If the alignment of the transmission event with the scheduled occurrence of another transmission event is within the associated interval adjustment tolerance, the transmission event can be rescheduled to occur concurrently with the scheduled occurrence of the other transmission event and the wireless interfaces of the two wireless devices can be activated concurrently with the scheduled occurrence of the other transmission event so as to conduct both transmission events, rather than activating the wireless interfaces twice to individually conduct each transmission event for each data service had the occurrence of the transmission event not been adjusted. Thus, by adjusting the scheduled occurrences of transmission events so as to align one or more transmission events within the same wireless interface activation period, the frequency of activation periods of the wireless interface of a wireless device can be reduced, thereby reducing the power consumption at the wireless device.

The term “interval adjustment tolerance,” as used herein, is defined as a requested or proposed limit to an amount by which a scheduled occurrence of a transmission event can be adjusted for the purpose of aligning the transmission event with one or more other transmission events. The adjustment to the scheduled occurrence of the transmission event can include, in one embodiment, a delay of the transmission event to a subsequent time, or, in an alternate embodiment, an advancement of the transmission event to an earlier time. Accordingly, an interval adjustment tolerance can include a delay tolerance, an advancement tolerance, or both, whereby the delay tolerance and the advancement tolerance of a data service may have the same magnitude or different magnitudes.

The terms “concurrent” and “concurrently”, as used herein, are defined as at least partially overlapping in time. To illustrate, if a first event initiates at time t₁ and terminates at time t₂ and a second event initiates at time t₃ (where time t₃ is not prior to time t₁) and terminates at time t₄, the first event and the second event are concurrent when time t₂ is subsequent to time t₃ because the first event and the second event overlap for the duration between time t₃ and time t₂.

For ease of discussion, various implementations disclosed herein are described in the context of an infrastructure network comprising a base station (e.g., an access point) and one or more portable wireless devices that communicate with one or more networks via the base station. However, the techniques described herein can be similarly employed in ad-hoc wireless networks or peer-to-peer wireless networks without departing from the scope of the present disclosure.

FIG. 1 illustrates a wireless network 100 utilizing a transmission event alignment technique in accordance with at least one embodiment of the present disclosure. The wireless network 100 includes a plurality of wireless devices, including wireless device 102 and a wireless device 104. For purposes of illustration, the wireless device 102 comprises a mobile station and the wireless device 104 comprises a base station in the example of FIG. 1. Accordingly, the wireless device 104 is connected to one or more networks 106 (illustrated as a single network) to provide uplink support (i.e., from the wireless device 102) and downlink support (i.e., from the network 106) for a plurality of data services utilized by the wireless device 102. In the depicted example, the plurality of data services includes a telephony service 108, a video service 110, and an Internet service 112. The telephony service 108 can include, for example, a VoIP voice service or other packetized voice service. The video service 110 can include, for example, a streaming video service from the Internet, a cable provider, or other video content provider. The Internet service 112 can include, for example, a network data service for communicating data from one or more networks (e.g., the Internet), whereby the communicated data can include, for example, transferred files, email data, web page data, and the like. The communicated data of the Internet service 112 also can include video data and voice data, such as when video is embedded in a web page accessed by a user of the wireless device 102.

The wireless device 102 includes a wireless interface 120 and a plurality of input/output (I/O) buffers, each I/O buffer corresponding to one of the plurality of data services and configured to buffer downlink data received from the wireless device 104 via the wireless interface 120, to buffer uplink data to be transmitted for reception by the wireless device 104 via the wireless interface 120, or a combination thereof. In the illustrated example, the plurality of I/O buffers includes an I/O buffer 122 to buffer data for the telephony service 108, an I/O buffer 124 to buffer data for the video service 110, and an I/O buffer 126 to buffer data for the Internet service 112. The wireless device 102 additionally includes components for processing, storing, or otherwise manipulating the data from some or all of the data services, such as a central processing unit (CPU) 128 and a memory 130 (e.g., random access memory or RAM). The wireless device 102 also can include a portable power supply 132, such as a battery, a solar panel, and the like.

In the depicted example, the wireless interface 120 includes a baseband processor 134 and a wireless transceiver 136. For downlink transmissions, the baseband processor 134 processes input signals from the wireless transceiver 136 to obtain the downlink data represented by the input signals and provides the downlink data for buffering in the appropriate I/O buffer. For uplink transmissions, the baseband processor 134 accesses uplink data from the appropriate I/O buffer, processes the accessed uplink data to generate one or more output signals, and provides the one or more output signals for transmission via the wireless transceiver 136. The wireless transceiver 136 can be configured to communicate in accordance with, for example, a metropolitan area network (MAN) protocol, local area network (LAN) protocol, a wide area network (WAN) protocol, a personal area network (PAN) protocol, or any combination thereof.

A WAN includes any of a variety of wireless networks having a wide coverage area, such as conventional cellular networks including, for example, code division multiple access (CDMA)-based networks, global system for mobile communication (GSM)-based networks, time division multiple access (TDMA)-based networks, universal mobile telecommunications system (UMTS)-based networks, and the like. A MAN includes any of a variety of wireless networks having a coverage area on a metropolitan scale, such a wireless network based on an Institute of Electrical and Electronics Engineers (IEEE) 802.16 standard (also referred to as “WiMax”). A LAN includes any of a variety of wireless networks having a local scale, such as a wireless network based on an IEEE 802.11 standard (also referred to as “WiFi”). A PAN includes any of a variety of wireless networks having a coverage area on a personal scale, such as a wireless network based on an IEEE 802.15 standard or a wireless network based on a Bluetooth™ standard, or an infrared network based on an Infra Red Data Association (IRDA) standard.

In one embodiment, the wireless device 102 further includes an activation controller 138, a transmission schedule data store 140, and an activation schedule data store 142. The activation controller 138 can be implemented as a program of instructions stored in the memory 130 or other storage and configured to manipulate the CPU 128 or other processing device to perform the functionality described herein. In another embodiment, the activation controller 138 is implemented as hardware, such as, for example, a hardware-based state machine implemented as an application specific integrated circuit (ASIC), programmable logic (e.g., a field programmable gate array (FPGA) device), and the like. Alternately, the activation controller 138 can be implemented as a combination of hardware and software.

The transmission schedule data store 140 and the activation schedule data store 142 each can be implemented as one or more registers, storage locations of the memory 130, and the like. In the depicted example, the transmission schedule data store 140 is logically implemented as a table, each entry of the table corresponding to a respective one of the plurality of data services supported by the wireless device 102. Each entry of the table includes a service field 144 identifying a corresponding data service, an interval field 146 identifying the transmission interval for the corresponding data service, and a tolerance field 148 identifying the interval adjustment tolerance for the corresponding data service. The interval adjustment tolerance for the corresponding data service includes an advancement tolerance, a delay tolerance, or both, depending on the implementation.

The activation schedule data store 142 is illustrated as being logically implemented as a table, each entry of the table corresponding to a scheduled activation period during which the wireless interface 120 is to be activated. Each entry includes an activation field 150 indicating a time associated with a corresponding activation period (e.g., the start time of the activation period) and a transmission event field 152 indicating one or more transmission events to be conducted during the corresponding activation period.

The activation controller 138 has access to the transmission schedule data store 140 and the activation schedule data store 142 and includes an input to receive a time reference signal 154 (e.g., a clock signal or an interrupt), and an output to provide an activation signal 156, whereby the wireless interface 120 is configured to activate when the activation signal 156 has one state (e.g., an asserted state) and to deactivate when the activation signal 156 has another state (e.g., a deasserted state). During steady-state or normal operation, the activation controller 138, in one embodiment, is configured to determine scheduled occurrences of transmission events for the data services based on the information of the transmission schedule data store 140 and update the activation schedule data store 142 accordingly. It will be appreciated that a transmission event may not actually occur at its scheduled time due to any of a variety of factors, such as when there is no data to be transmitted due to, for example, delays elsewhere in the network. During the steady-state or normal operation, the activation controller 138 further is configured to activate the wireless interface 120 using the activation signal 156 for each activation period indicated by the activation schedule data store 142, as well as being configured to conduct the one or more transaction events identified by the activation schedule data store 142 or otherwise associated with the enacted activation period.

During a configuration operation, the activation controller 138, in one embodiment, is configured to determine the transmission interval and/or the interval adjustment tolerance for one or more of the plurality of data services and update the transmission schedule data store 140 accordingly. Further the activation controller 138 is configured to provide an indicator of the transmission interval and/or the interval adjustment tolerance for reception by the wireless device 104, where the indicator can be transmitted as part of an inter-device message, such as a sleep request message.

In one embodiment, the activation controller 138 determines the next scheduled occurrence of a transmission event for some or all of the data services based on the transmission interval associated with the data service. To illustrate, the depicted entry of the transmission schedule data store 140 associated with the telephony service 108 indicates that the transmission interval of the telephony service 108 is twenty milliseconds. Accordingly, the first transmission event for the telephony service 108 is scheduled to occur after twenty milliseconds elapses from some initial time, and subsequent transmission events for the telephony service are scheduled to occur at twenty millisecond intervals thereafter. Likewise, the depicted entry of the transmission schedule data store 140 associated with the video service 110 indicates that the transmission interval of the video services is thirty-three milliseconds. Therefore, the first transmission event for the video service 110 is scheduled to occur after thirty-three milliseconds elapses from some initial time (which may be different than the initial time of the telephony service 108), and subsequent transmission events for the telephony service are scheduled to occur at thirty-three millisecond intervals thereafter. The transmission intervals for the Internet service 112 can be similarly scheduled to occur at the indicated fifty millisecond intervals. The activation controller 138 can update the activation schedule data store 142 to reflect the determined scheduled occurrence of transmission events.

After determining the scheduled occurrence of the upcoming transmission event for each of the data services, the activation controller 138 determines whether the scheduled occurrence of a selected transmission event can be adjusted, subject to the corresponding interval adjustment tolerance, so as to align the adjusted scheduled occurrence of the selected transmission event with one or more other transmission events. In one embodiment, the activation controller 138 determines the adjustment range for each of at least a subset of upcoming transmission events based on the scheduled occurrence of the transmission event and the interval adjustment tolerance of the data service associated with the transmission event. To illustrate, assume that a transmission event is scheduled to occur at time t₁ and the interval adjustment tolerance of a data service associated with the transmission event has a delay tolerance of five milliseconds and an advancement tolerance of zero milliseconds (i.e., no advancement tolerance). In this example, the adjustment range of the scheduled occurrence of the transmission event would be (t₁ . . . t₁+5 ms) (i.e., the time period between time t₁ and five milliseconds thereafter). As another example, assume that a transmission event is scheduled to occur at time t₂ and the interval adjustment tolerance of the data service associated with the transmission event has a delay tolerance of ten milliseconds and an advancement tolerance of three milliseconds. In this example, the adjustment range of the scheduled occurrence of the transmission event would be (t₂−3 ms . . . t₂+10 ms)(i.e., the time period between three milliseconds before time t₂ and ten milliseconds after time t₂). As another example, assume that a transmission event is scheduled to occur at time t₃ and the interval adjustment tolerance of the data service associated with the transmission event has a delay tolerance of zero milliseconds and an advancement tolerance of four milliseconds. In this example, the adjustment range of the scheduled occurrence of the transmission event would be (t₃−4 ms . . . t₃)(i.e., the time period between four milliseconds before time t₃ and time t₃).

In one embodiment, each transmission event of at least a subset of the upcoming transmission events are selected in turn to determine if the selected transmission event can be aligned with an occurrence of at least one other transmission event. In the event that the data service corresponding to the selected transmission event has both a non-zero advancement tolerance and a non-zero delay tolerance, the activation controller 138 can attempt to align the selected transmission event with a transmission event of another data service scheduled to occur before the selected transmission event or a transmission event of another data service scheduled to occur after the selected transmission event. In at least one embodiment, the scheduled occurrence of a selected transmission event can be advanced in time or delayed in an effort to align multiple transmission events for a single activation period of the wireless interface 120 that otherwise would require multiple separate activation periods of the wireless interface 120 or an extended activation period. Accordingly, after determining the adjustment ranges of the upcoming transmission events, the activation controller 138 determines whether any of the upcoming transmission events can be aligned to occur concurrently by determining whether any of the upcoming transmission events have concurrent adjustment ranges (i.e., at least partially overlapping adjustment ranges).

To illustrate, assume a first transmission event is scheduled to occur at 30 ms after an initial event of a first data service and has an adjustment range (30 ms . . . 35 ms) (i.e., a 5 ms delay tolerance) and a second transmission event of a second data service is scheduled to occur at 33 ms after the initial event and has an adjustment range (33 ms . . . 38 ms) (i.e., a 5 ms delay tolerance). In this example, the adjustment ranges are concurrent for the time period (33 ms . . . 35 ms). Therefore, the activation controller 138 can delay the scheduled occurrence of the first transmission event so as to occur at 33 ms so that both the first transmission event and the second transmission event are scheduled concurrently and therefore both can be conducted during the same activation period of the wireless interface 120. By way of another example, assume a first transmission event of a first data service is scheduled to occur at 45 ms after an initial event and has an adjustment range (40 ms . . . 55 ms) (i.e., a 10 ms delay tolerance and a 5 ms advancement) and a second transmission event of a second data service is scheduled to occur at 60 ms after the initial event and has an adjustment range (50 ms . . . 80 ms) (i.e., a 10 ms advancement tolerance and a 20 ms delay tolerance). In this example, the adjustment ranges overlap for the time period (50 ms . . . 55 ms). In certain instances, it may be advantageous to attempt to minimize the amount of time a transmission event is advanced, if advancement of the transmission event is permitted at all. Accordingly, in this example, the scheduled occurrence of the first transmission event can be delayed by ten milliseconds to occur at 55 milliseconds and the scheduled occurrence of the second transmission event can be advanced by five milliseconds to also occur at 55 milliseconds, thereby minimizing the amount by which the second transmission event is advanced while achieving alignment between the first transmission event and the second transmission event. In other instances, it may be advantageous to attempt to minimize the amount of adjustment to any one transmission event. Accordingly, in this example, the scheduled occurrence of the first transmission event can be delayed by eight milliseconds to occur at 53 milliseconds and the scheduled occurrence of the second transmission event can be advanced by seven milliseconds to also occur at 53 milliseconds, thereby more equally distributing the total adjustment between the first transmission event and the second transmission event while achieving alignment between the first transmission event and the second transmission event. In yet another instance, it may be a requirement to minimize the amount of adjustment to transmission events of a particular data service.

If the adjustment required to align the occurrence of the selected transmission event with the occurrence of another transmission event of another data service is no greater than the interval adjustment tolerance for the selected transmission event, the activation controller 138, in one embodiment, determines an adjustment suitable to align the selected transmission event with a transmission event of another data service and adjusts the scheduled occurrence of the selected transmission event by the determined adjustment. In one embodiment, the adjustment to the scheduled occurrence of the selected transmission event is enacted by updating the activation schedule data store 142 by adding an indicator of the selected transmission event to the entry corresponding to the new time for the adjusted scheduled occurrence of the selected transmission event and removing the indicator of the selected transmission event from the entry corresponding to the time for the original scheduled occurrence of the selected transmission event. As discussed above, the alignment of transmission events may involve adjusting the scheduled occurrences of multiple transmission events and therefore may involve the modification of multiple entries of the activation schedule data store 142.

Further, in at least one embodiment, an adjustment to a scheduled occurrence of a transmission event of a data services does not effect the scheduling of subsequent transmission events for the data service. For example, assume a data service has a transmission interval of twenty milliseconds whereby a transmission event is initially scheduled to occur at 20 ms and another transmission event is initially scheduled to occur at 40 ms. The adjustment of the first transmission event so as to occur at 25 ms, in this instance, would not automatically result in the adjustment of the other transmission event at 45 ms so as to maintain the twenty millisecond interval between transmission events. In other words, the adjustment to a scheduled occurrence of a transmission event of a data services does not alter the average frequency of transmission events for the data service.

If the adjustment required to align the occurrence of the selected transmission event with the occurrence of another transmission event of another data service is greater than the interval adjustment tolerance of the selected transmission event, in one embodiment no modification is made to the scheduled occurrence of the selected transmission event and the activation controller 138 activates the wireless interface 120 to conduct the selected transmission event at the time of the original scheduled occurrence of the selected transmission event.

The wireless device 104 includes a network interface 158 configured to interface with one or more networks such as network 106, a wireless interface 160, and a plurality of I/O buffers, including I/O buffers 162, 164, and 166, each I/O buffer corresponding to one of the plurality of data services and configured to buffer uplink data received from the wireless device 102 via the wireless interface 160, to buffer downlink data to be transmitted for reception by the wireless device 102 via the wireless interface 160, or a combination thereof. The wireless device 104 additionally includes components for processing, storing, or otherwise manipulating the data from some or all of the data services, such as a central processing unit (CPU) 168 and a memory 170.

As with the wireless interface 120, the wireless interface 160 includes a baseband processor 174 and a wireless transceiver 176. For uplink transmission from the wireless device 102, the baseband processor 174, in one embodiment, processes input signals from the wireless transceiver 176 to obtain the uplink data represented by the input signals and provides the uplink data for buffering in the appropriate I/O buffer. For downlink transmissions to the wireless device 102, the baseband processor 174, in one embodiment, accesses downlink data from the appropriate I/O buffer, processes the accessed downlink data to generate one or more output signals, and provides the one or more output signals for transmission via the wireless transceiver 176. The wireless transceiver 176 can be configured to communicate in accordance with, for example, a MAN protocol, a LAN protocol, a WAN protocol, a PAN protocol, or any combination thereof.

In one embodiment, the wireless device 104 further includes an activation controller 178, a transmission schedule data store 180, and an activation schedule data store 182 (equivalent to the activation controller 138, the transmission schedule data store 140, and the activation schedule data store 142, respectively, of the wireless device 102). The activation controller 178 has access to the transmission schedule data store 180 and the activation schedule data store 182 and includes an input to receive a time reference signal 194 and an output to provide an activation signal 196, whereby the wireless interface 160 is configured to enter an active state when the activation signal 156 has one state (e.g., an asserted state) and to enter an inactive state when the activation signal 156 has another state (e.g., a deasserted state). In parallel with the activation controller 138 of the wireless device 102, the activation controller 178, in one embodiment, is configured to: determine scheduled occurrences of transmission events for the data services based on the information of the transmission schedule data store 180 and update the activation schedule data store 182 accordingly; activate the wireless interface 160 for each activation period of a sequence of activation periods indicated by the activation schedule data store 182; and conduct the one or more transaction events identified by the activation schedule data store 182 or otherwise associated with the enacted activation period. During a configuration operation, the activation controller 178, in one embodiment, is configured to determine the transmission interval and/or the interval adjustment tolerance for one or more of the plurality of data services and update the transmission schedule data store 180 accordingly. Alternately, in one embodiment, the activation controller 178 is configured to provide an indicator of the transmission interval and/or the interval adjustment tolerance for reception by the wireless device 102, where the indicator can be transmitted as part of an inter-device message, such as a sleep request message.

In one embodiment, the information of the transmission schedule data store 180 related to the data services supported by the wireless device 104 substantially matches the corresponding information of the transmission schedule data store 140 of the wireless device 102 during steady-state or normal operation. Accordingly, in one embodiment, the activation controller 178 performs the activation schedule determination process described above in parallel with the activation controller 138. Accordingly, as both the activation controller 138 and the activation controller 178 have access to the same transmit schedule information with respect to the supported data services, the activation controller 138 and the activation controller 178 each can determine the same activation schedule with respect to the transmission events of the supported data services, including any adjustments so as to align transmission events. As a result, the activation controller 138 and the activation controller 178 each can individually activate their respective wireless interfaces for concurrent activation periods during which the scheduled transmission events are conducted between the wireless device 102 and the wireless device 104.

As noted above, the wireless device 102 is implemented as a mobile station and the wireless device 104 is implemented as a base station in the example of FIG. 1. As such, the wireless device 102 likely has a relatively limited supply of power, such as a battery, whereas the wireless device 104 likely has an effectively unlimited supply of power, such as via a power grid. In view of the limited power supply of the wireless device 102, deactivating the wireless interface 120, in one embodiment, includes configuring the wireless interface 120 to enter an inactive state whereby the wireless interface 120 operates in a substantially reduced power mode, such as by clock gating one or both of the wireless transceiver 136 and the baseband processor 134, by providing a reduced frequency clock signal to one or both of the wireless transceiver 136 and the baseband processor 134, or by removing one or more voltage supplies from one or both of the wireless transceiver 136 and the baseband processor 134. Likewise, activating the wireless interface 120, in one embodiment, includes configuring the wireless transceiver to enter an active state whereby the wireless interface 120 operates in a normal power mode, such as by initiating the provision of a normal frequency clock signal to one or both of the wireless transceiver 136 and the baseband processor 134 or by initiating the provision of one or more voltage supplies to the wireless transceiver 136 and the baseband processor 134. In contrast, due to the lessened concern for power savings for the wireless device 104, deactivating the wireless interface 160, in one embodiment, includes configuring the wireless interface 160 so as to no longer support at least one wireless channel with the wireless device 102, while remaining configured to support wireless channels with other wireless devices. Activating the wireless interface 160 therefore includes configuring the wireless interface 160 to initiate and support at least one wireless channel with the wireless device 102.

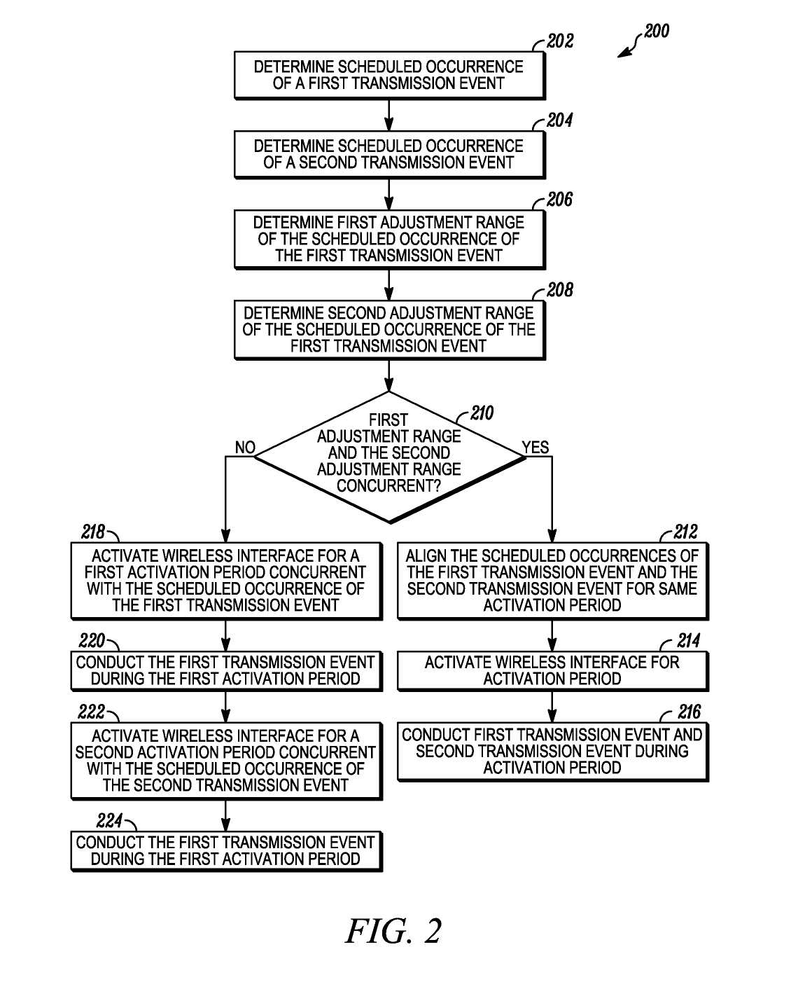

FIG. 2 illustrates a flow diagram 200 of a method for aligning occurrences of transmission events among a plurality of data services at a wireless device based on one or more corresponding interval adjustment tolerances in accordance with at least one embodiment of the present disclosure. In at least one embodiment, the method is performed in parallel at the wireless devices that are communicating the data associated with the data services so as to synchronize the wireless interface activation periods of the wireless devices.

The flow diagram 200 includes determining a scheduled occurrence of an upcoming first transmission event of a first data service at block 202 and determining a scheduled occurrence of an upcoming second transmission event of a second data service at block 204. A scheduled occurrence of an upcoming transmission event can be determined based on the transmission interval of the data service. Accordingly, an upcoming transmission event can be determined to be scheduled to occur at the elapse of the current transmission interval. In one embodiment, the first transmission event of the first data service is for a telephony service type and the second transmission event of the second data service is for a dissimilar service type such as video service. In another embodiment, the first transmission event is for a first instance of a telephony service type and the second transmission event is for a second instance of a similar telephony service type (e.g., the uplink and downlink transmissions conducted during a VoIP-based telephone call).

The flow diagram 200 further includes determining a first adjustment range of the first transmission event at block 206 and determining a second adjustment range of the second transmission event at block 208. The adjustment range of a transmission event is based on the scheduled occurrence of the transmission event and the interval adjustment tolerance of the scheduled occurrence, including the delay tolerance, the advancement tolerance, or both. To illustrate, assuming a transmission event is scheduled to occur at time t and the transmission event has a delay tolerance of X ms and an advancement tolerance of Y ms (where X and Y each is zero or greater), the adjustment range of the transmission event is (t−Y . . . t+X).

At block 210, the flow diagram 200 includes determining whether the first adjustment range and the second adjustment range are concurrent (i.e., overlap). In the event that the first adjustment range and the second adjustment range are concurrent, the flow diagram 200 returns to block 212. At block 212, the flow diagram 200 includes aligning the first transmission event and the second transmission event so that they are scheduled to occur during the same activation period of a wireless interface for the wireless device. In at least one embodiment, the alignment of the first and second transmission events includes adjusting their scheduled occurrences so that they occur concurrently or within a predetermined tolerance of each other, the predetermined tolerance based on the position and duration of the wireless interface activation period. In instances whereby an alignment of more than two transmission events is to be attempted, the process represented by blocks 202-212 can be repeated for each permutation of the transmission events.

In one embodiment, the degree of adjustment to each of the scheduled occurrences of the first transmission event and the second transmission event used to align the first transmission event and the second transmission event can depend on a variety of factors. As noted above, in some instances it may be advantageous to maximize the amount by which one transmission event is delayed before advancing another transmission event for alignment purposes. In other instances, it may be advantageous to more equally distribute the amount of adjustment between the transmission events to be aligned. In yet other instances, the data services can be prioritized whereby the scheduled occurrence of a transmission event associated with a higher priority data service is adjusted less than a scheduled occurrence of a transmission event associated with a lower priority data service.

After aligning the first and second transmission events by adjusting the scheduling of one or both of the first transmission event and the second transmission event, the flow diagram 200 includes activating the wireless interface of the wireless device for an activation period concurrent with the aligned occurrences of the first and second transmission events at block 214. In the event that the wireless device has a limited power supply, such as a mobile device with a battery, activation of the wireless interface for the activation period includes providing a normal frequency clock signal and/or applying one or more supplies of voltage to the wireless interface for the duration of the activation period. In the event that the wireless device has a less limited power supply, such as an access point, activation of the wireless interface for the activation period includes configuring the wireless interface to initiate a wireless channel with another wireless device associated with the first and second transmission events and to support the wireless channel for the duration of the activation period.

At block 216, the flow diagram 200 includes conducting the first transmission event and the second transmission event during the activation period. The first transmission event and the second transmission event each can include a transmission of uplink data associated with a data service and/or a transmission of downlink data service associated with a data service. Accordingly, if the wireless device is the mobile station, conducting a transmission of uplink data at the wireless device includes wirelessly transmitting the uplink data for reception by a base station and conducting a transmission of downlink data at the wireless device includes wirelessly receiving the downlink data from a base station. If the wireless device is the base station, conducting a transmission of uplink data at the wireless device includes wirelessly receiving the uplink data from a mobile station and conducting a transmission of downlink data at the wireless device includes wirelessly transmitting the downlink data for reception by a mobile station.

In the event that the first adjustment range and the second adjustment range are not concurrent, the scheduled occurrences of the first transmission event and the second transmission event remain unaltered and the flow diagram 200 goes from block 210 to block 218. At block 218, the flow diagram 200 includes activating the wireless interface of the wireless device for a first activation period concurrent with the scheduled occurrence of the first transmission event and at block 220 the flow diagram 200 includes conducting the first transmission event during the first activation period. At block 222, the flow diagram 200 includes activating the wireless interface of the wireless device for a second activation period concurrent with the scheduled occurrence of the second transmission event and at block 224 the flow diagram 200 includes conducting the second transmission event during the second activation period.

As illustrated by flow diagram 200, the alignment of two or more transmission events that otherwise are scheduled to occur at separate times can result in a reduction in the frequency of wireless interface activation periods when a wireless device is operating using more than one data service, thereby reducing the power consumption of the wireless device. For example, blocks 210, 212, 214, and 216 illustrate that a single wireless interface activation period can be used to conduct two different transmission events when their respective adjustment ranges overlap, whereas blocks 210, 218, 220, 222, and 224 illustrate that two separate wireless interface activation periods are used to conduct two different transmission events when their respective adjustment ranges do not overlap or adjustments to their scheduled occurrences are otherwise not accomplished.

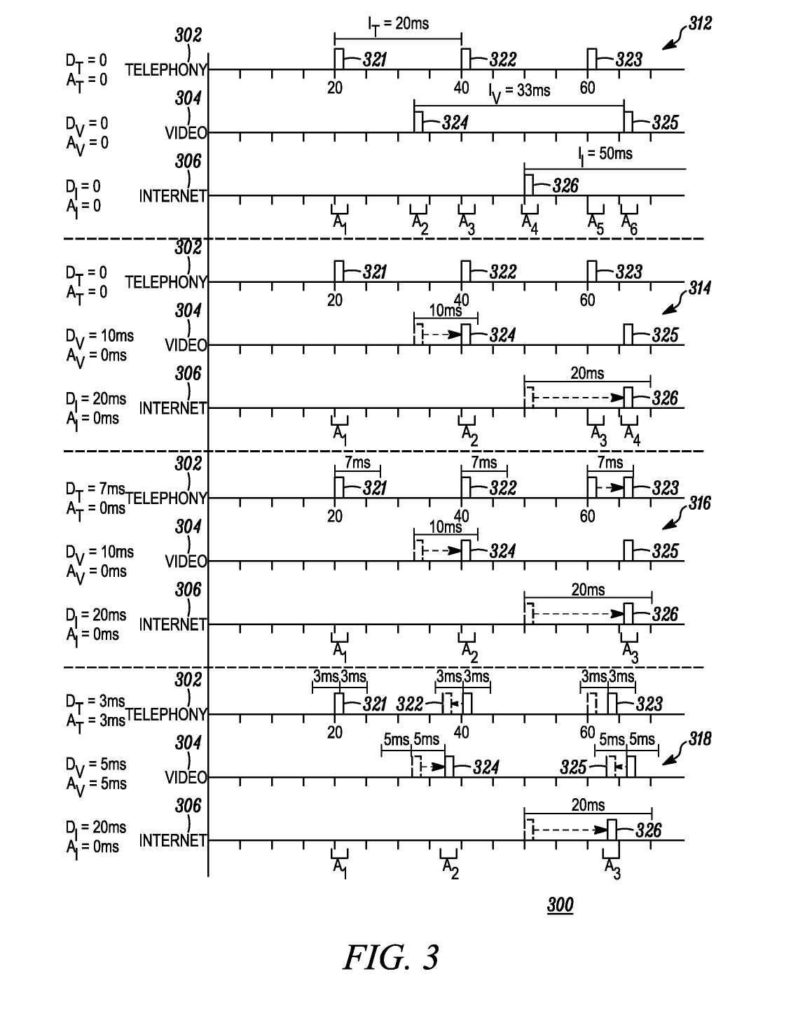

FIG. 3 illustrates examples of scheduling alignments of transmission events for a plurality of data services at a wireless device in accordance with at least one embodiment of the present disclosure. The scheduling process illustrated by FIG. 3, in one embodiment, is individually performed in parallel by two or more wireless devices communicating the data of the plurality of data services, such as a base station and a mobile station, so as to synchronize their wireless interface activation periods for wirelessly communicating data. For ease of illustration, each of the activation periods of FIG. 3 is illustrated as having the same duration (e.g., 2 ms). However, it will appreciated that the activation periods may vary in duration depending on any of a variety of factors, including the amount of data to be transmitted for each transmission event occurring during the activation period, the number of transmission events conducted during the activation period, the degree and complexity of channel setup (e.g., handshaking), and the like.

The illustrated chart 300 includes various transmission event schedules for a telephony service 302, a video service 304, and an Internet service 306. The example transmission event schedules includes a transmission event schedule 312 whereby the telephony service 302 has an interval adjustment tolerance including a delay tolerance of zero milliseconds (D_{T}=0 ms) and an advancement tolerance of zero milliseconds (A_{T}=0 ms), the video service 304 has an interval adjustment tolerance including a delay tolerance of zero milliseconds (D_{V}=0 ms) and an advancement tolerance of zero milliseconds (A_{V}=0 ms), and the Internet service 306 has an interval adjustment tolerance including a delay tolerance of zero milliseconds (D_{I}=0 ms) and an advancement tolerance of zero milliseconds (A_{I}=0 ms). It will be appreciated that the transmission event schedule 312 represents a conventional transmission scheduling process whereby an interval adjustment tolerance is not used for transmission event alignment purposes.

The chart 300 also includes a transmission event schedule 314 whereby the telephony service 302 has an interval adjustment tolerance including a delay tolerance of zero milliseconds (D_{T}=0 ms) and an advancement tolerance of zero milliseconds (A_{T}=0 ms), the video service 304 has an interval adjustment tolerance including a delay tolerance of ten milliseconds (D_{V}=10 ms) and an advancement tolerance of zero milliseconds (A_{V}=0 ms), and the Internet service 306 has an interval adjustment tolerance including a delay tolerance of twenty milliseconds (D_{I}=20 ms) and an advancement tolerance of zero milliseconds (A_{I}=0 ms).

The chart 300 further includes a transmission event schedule 316 whereby the telephony service 302 has an interval adjustment tolerance including a delay tolerance of seven milliseconds (D_{T}=7 ms) and an advancement tolerance of zero milliseconds (A_{T}=0 ms), the video service 304 has an interval adjustment tolerance including a delay tolerance of ten milliseconds (D_{V}=10 ms) and an advancement tolerance of zero milliseconds (A_{V}=0 ms), and the Internet service 306 has an interval adjustment tolerance including a delay tolerance of twenty milliseconds (D_{I}=20 ms) and an advancement tolerance of zero milliseconds (A_{I}=0 ms).

The chart 300 additionally includes a transmission event schedule 318 whereby the telephony service 302 has an interval adjustment tolerance including a delay tolerance of three milliseconds (D_{T}=3 ms) and an advancement tolerance of three milliseconds (A_{T}=3 ms), the video service 304 has an interval adjustment tolerance including a delay tolerance of five milliseconds (D_{V}=5 ms) and an advancement tolerance of five milliseconds (A_{V}=5 ms), and the Internet service 306 has an interval adjustment tolerance including a delay tolerance of twenty milliseconds (D_{I}=20 ms) and an advancement tolerance of zero milliseconds (A_{I}=0 ms).

In the example of FIG. 3, the telephony service 302 includes transmission events 321, 322, 323 scheduled to occur at twenty millisecond intervals (I_{T}=20 ms) from an initial time such that the transmission event 321 is initially scheduled to occur at 20 ms, the transmission event 322 is initially scheduled to occur at 40 ms, and the transmission event 323 is initially scheduled to occur at 60 ms. The video service 304 includes transmission events 324, 325 scheduled to occur at thirty-three millisecond intervals (I_{V}=33 ms) from the initial time such that the transmission event 324 is initially scheduled to occur at 33 ms and the transmission event 325 is initially scheduled to occur at 66 ms. The Internet service 306 includes a transmission event 326 scheduled to occur at a fifty millisecond interval (I_{I}=50 ms) from the initial time such that the transmission event 326 is initially scheduled to occur at 50 ms. Note that it is assumed for the example of FIG. 2 that the transmission intervals for the telephony service 302, the video service 304, and the Internet service 306 all initiate at the same time for ease of illustration; it will be appreciated that the transmission interval for each data service alternately may initiate at a different time.

As illustrated by the transmission event schedule 312 whereby no interval adjustment tolerance is utilized to align transmission events, each of the transmission events 321, 322, 323, 324, 325, 326 requires a separate wireless interface activation period, resulting in six wireless interface activation periods A₁, A₂, A₃, A₄, A₅, A₆. For the transmission event schedule 314, however, the transmission event 324 has an adjustment range of (33 ms . . . 43 ms), which is concurrent with the scheduled occurrence of the transmission event 322, and the transmission event 326 has an adjustment range of (50 ms . . . 70 ms), which is concurrent with the scheduled occurrence of the transmission event 325. Accordingly, the scheduled occurrence of the transmission event 324 can be adjusted so as to delay the transmission event 324 until 40 ms so as to align with the transmission event 322. Likewise, the scheduled occurrence of the transmission event 326 can be adjusted so as to delay the transmission event 326 until 66 ms so as to align the transmission event 326 and the transmission event 325 for the same wireless interface activation period concurrent with the 66 ms mark. The adjustments to the scheduled occurrences of the transmission events 324, 326 results in a reduction of the wireless activation periods from six wireless activation periods to only four wireless interface activation periods B₁, B₂, B₃, B₄, which results in the implementation of the transmission event schedule 314 at a wireless device having a reduced power consumption compared to the implementation of the transmission event schedule 312.

For the transmission event schedule 316, the transmission event 324 has an adjustment range of (33 ms . . . 43 ms), which is concurrent with the scheduled occurrence of the transmission event 322. The transmission event 326 has an adjustment range of (50 ms . . . 70 ms), which is concurrent with the scheduled occurrence of the transmission event 325. Additionally, the transmission event 323 has an adjustment range of (60 ms . . . 67 ms), which is concurrent with the scheduled occurrence of the transmission event 325. Accordingly, the scheduled occurrence of the transmission event 324 can be adjusted so as to delay the transmission event 324 until 40 ms so as to align the transmission event 322 with the transmission event 324. The scheduled occurrences of the transmission event 323 and the transmission event 326 can be adjusted so as to delay the transmission event 323 and the transmission event 326 until 66 ms so as to align the transmission event 323, the transmission event 326, and the transmission event 325 for the same wireless interface activation period concurrent with the 66 ms mark. The adjustments to the scheduled occurrences of the transmission events 323, 324, and 326 results in a reduction of the wireless activation periods from six wireless activation periods to only three wireless interface activation periods C₁, C₂, C₃, which results in the implementation of the transmission event schedule 316 at a wireless device having a reduced power consumption compared to the implementations of the transmission event schedules 312 and 314.

For the transmission event schedule 318, the transmission event 324 has an adjustment range of (28 ms . . . 38 ms), which is concurrent with the adjustment range of (37 ms . . . 43 ms) of the transmission event 322 for a time period of (37 ms . . . 38 ms). Accordingly, the scheduled occurrence of the transmission event 322 can be advanced to 37 ms and the scheduled occurrence of the transmission event 324 can be delayed to 37 ms so as to align the transmission event 322 with the transmission event 324. Further, the transmission event 323 has an adjustment range of (57 ms . . . 63 ms), the transmission event 325 has an adjustment range of (61 ms . . . 71 ms), and the transmission event 326 has an adjustment range of (50 ms . . . 70 ms), and thus the adjustment ranges of the transmission events 323, 325, and 326 are concurrent for a time period of (61 ms . . . 63 ms). Therefore, the scheduled occurrence of the transmission event can be delayed to 63 ms, the scheduled occurrence of the transmission event 325 can be advanced to 63 ms, and the scheduled occurrence of the transmission event 326 can be delayed to 63 ms so as to align the transmission event 322, the transmission event 325, and the transmission event 236 for the same wireless interface activation period concurrent with the 63 ms mark. The adjustments to the scheduled occurrences of the transmission events 323, 324, 325, 326 results in a reduction of the wireless activation periods from six wireless activation periods to only three wireless interface activation periods D₁, D₂, D₃, which results in the implementation of the transmission event schedule 318 at a wireless device having a reduced power consumption compared to the implementations of the transmission event schedules 312 and 314.

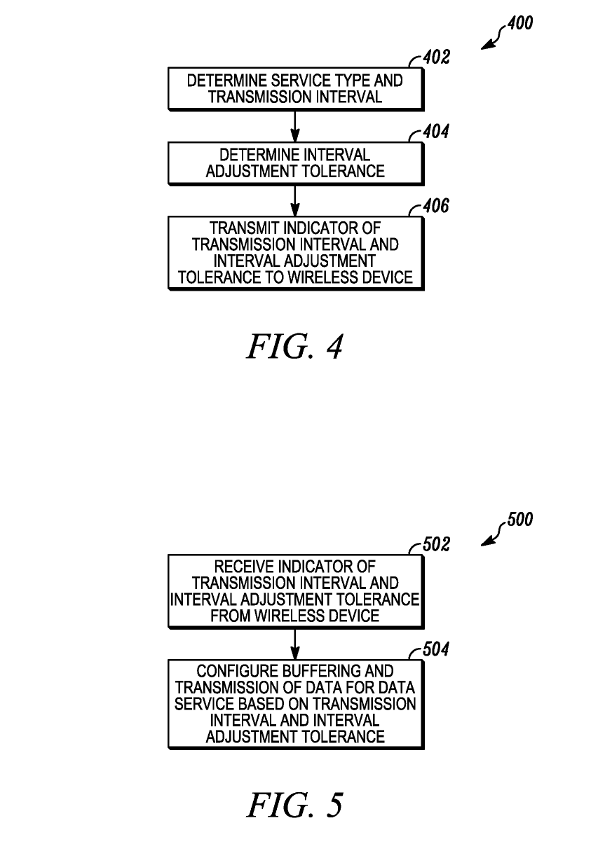

FIG. 4 illustrates a flow diagram 400 of a method for providing an indicator of an interval adjustment tolerance of a data service from a first wireless device to another wireless device in accordance with at least one embodiment of the present disclosure. The first wireless device can include a mobile station and the second wireless device can include a base station, or vice versa. The flow diagram 400 can be repeated for each data service implemented between the first wireless device and the second wireless device.

The flow diagram 400 includes determining a service type and a transmission interval of the data service at block 402. The service type represents the type of data provided by the data service, such as telephony, video, Internet data, and the like. In one embodiment, the transmission interval is based on the data service. For example, a telephony service may have a default transmission interval of twenty milliseconds so as to comply with an expected quality-of-service (QoS) for the telephony service, whereas an Internet service may have a default transmission interval of one hundred milliseconds due to the typically low QoS requirement of Internet data. The transmission interval for a data service can be fixed for the data service and determining the transmission interval therefore can include accessing a storage location having an indicator of the transmission interval or accessing a table listing default transmission intervals based on service type. In another embodiment, the transmission interval can be user or network defined and determining the transmission interval therefore can include receiving user or network input indicating a desired transmission interval or QoS related to desired transmission interval for the data service.

The flow diagram 400 further includes determining an interval adjustment tolerance for the data service at block 404. As with the transmission interval, the interval adjustment tolerance may correspond to or otherwise be based on the service type of the data service. To illustrate, due to the buffering capabilities of video display devices and the relative insensitivity to jitter, a video service may have a larger interval adjustment tolerance compared to a telephony service which may have a smaller interval adjustment tolerance, or no interval adjustment tolerance, due to heightened QoS and real time transmission expectations. Determining the transmission interval therefore can include accessing a storage location having an indicator of the interval adjustment tolerance or accessing a table listing default interval adjustment tolerances based on service type. Alternately, the interval adjustment tolerance can be user or network defined and determining the interval adjustment tolerance therefore can include receiving user or network input indicating a desired interval adjustment tolerance for the data service. Further, the interval adjustment tolerance can be based on the corresponding transmission interval, such as proportional to the transmission interval. Note that 404 can be performed before 402.

The flow diagram 400 further includes transmitting an indicator of the interval adjustment tolerance from the first wireless device for reception by the second wireless device at block 406. In one embodiment, the indicator is provided during a sleep mode negotiation between a base station and a mobile station. The indicator therefore can include a sleep request message in accordance with an IEEE 802.XX standard, such as the IEEE 802.11 standard or the IEEE 802.16 standard. To illustrate, IEEE 802.16e utilizes a sleep request MOB_SLP-REQ message sent between a mobile station and a base station that is used by the mobile station to negotiate a sleep mode with the base station. In one implementation, this sleep request message can be modified to include one or more fields to include an indicator of an interval adjustment tolerance, as well as the transmission interval, for the corresponding data service.

FIG. 5 illustrates a flow diagram 500 of a method for receiving and implementing an indicator of an interval adjustment tolerance at a first device from a second device in accordance with at least one embodiment of the present disclosure. The first wireless device can include a mobile station and the second wireless device can include a base station, or vice versa. The flow diagram 500 can be repeated for each data service implemented between the first wireless device and the second wireless device.

The flow diagram 500 includes receiving, at the first device, an indicator of an interval adjustment tolerance associated with a data service from a second device at block 502. The flow diagram 500 further can include receiving, at the first device, an indicator of a transmission interval of the data service at block 502. The indicator can include, for example, a sleep request message in accordance with an IEEE 802.XX standard, such as, for example, a modified sleep request MOB_SLP-REQ message in accordance with IEEE 802.16e.

The flow diagram 500 also includes configuring the first wireless device in accordance with the indicated interval adjustment tolerance and transmission interval of the data service at block 504. As discussed above with reference to FIG. 1, configuring the first wireless device can include updating a transmission schedule data store to incorporate the indicated interval adjustment tolerance and transmission interval for an entry corresponding to the data service. The first wireless device then can implement the transmission event alignment process described herein utilizing the indicated interval adjustment tolerance and transmission interval.

The preceding description is intended to convey a thorough understanding of the present disclosure by providing a number of specific embodiments and details involving aligning transmission events in a wireless network. It is understood, however, that the present disclosure is not limited to these specific embodiments and details, which are exemplary only, and the scope of the disclosure is accordingly intended to be limited only by the following claims and equivalents thereof. It is further understood that one possessing ordinary skill in the art, in light of known systems and methods, would appreciate the use of the invention for its intended purposes and benefits in any number of alternative embodiments, depending upon specific design and other needs.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present disclosure, further discussion of such software and ICs, if any, will be limited to the essentials with respect to the principles and concepts within the various embodiments.

It will be appreciated that the methods and the wireless devices described herein may include one or more conventional processors and unique stored program instructions that control the one or more processors, to implement, in conjunction with certain non-processor circuits, some of the functions of the electronic device described herein. The non-processor circuits may include, but are not limited to, a radio receiver, a radio transmitter, signal drivers, clock circuits, power source circuits, and user input devices.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

What is claimed is:

1. A method comprising:
determining, at a first wireless device, a first scheduled occurrence of a first transmission event associated with a first data service based on a first transmission interval associated with the first data service;
determining, at the first wireless device, a second scheduled occurrence of a second transmission event associated with a second data service based on a second transmission interval associated with the second data service;
adjusting the first scheduled occurrence of the first transmission event to align the first transmission event with the second transmission event in response to determining that the second scheduled occurrence is within a non-zero first interval adjustment tolerance of the first scheduled occurrence, the first interval adjustment tolerance associated with the first data service; and
activating a wireless interface of the first wireless device for an activation period concurrent with the second scheduled occurrence for conducting the first transmission event and the second transmission event in response to adjusting the first scheduled occurrence.

2. The method of claim 1, further comprising:
activating the wireless interface for an activation period concurrent with the first scheduled occurrence for conducting the first transmission event and separately activating the wireless interface for an activation period concurrent with the second scheduled occurrence for conducting the second transmission event in response to determining that the second scheduled occurrence is not within the first interval adjustment tolerance of the first scheduled occurrence.

3. The method of claim 1, further comprising:
determining, at the first wireless device, a third scheduled occurrence of a third transmission event associated with a third data service based on a third transmission interval associated with the third data service;
adjusting the third scheduled occurrence of the third transmission event to align the third transmission event with the second transmission event in response to determining that the second scheduled occurrence is within a non-zero third interval adjustment tolerance of the third scheduled occurrence, the third interval adjustment tolerance associated with the third data service; and
activating the wireless interface for an activation period concurrent with the second scheduled occurrence for conducting the first transmission event, the second transmission event, and the third transmission event in response to adjusting the first scheduled occurrence and adjusting the third scheduled occurrence.

4. The method of claim 1, further comprising:
determining, at the first wireless device, a third scheduled occurrence of a third transmission event associated with a third data service based on a third transmission interval associated with the third data service;
activating the wireless interface for an activation period concurrent with the second scheduled occurrence for conducting the first transmission event and the second transmission event in response to adjusting the first scheduled occurrence; and
separately activating the wireless interface for an activation period concurrent with the third scheduled occurrence for conducting the third transmission event in response to determining that the second scheduled occurrence is not within a non-zero third interval adjustment tolerance of the third scheduled occurrence, the third interval adjustment tolerance associated with the third data service.

5. The method of claim 1, further comprising:
determining, at a second wireless device, the first scheduled occurrence of the first transmission event based on the first transmission interval;
determining, at the second wireless device, the second scheduled occurrence of the second transmission event based on the second transmission interval;
adjusting, at the second wireless device, the first scheduled occurrence of the first transmission event to align the first transmission event with the second transmission event in response to determining that the second scheduled occurrence is within the first interval adjustment tolerance of the first scheduled occurrence; and
activating a wireless interface of the second wireless device for an activation period concurrent with the second scheduled occurrence for conducting the first transmission event and the second transmission event in response to adjusting the first scheduled occurrence at the second wireless device.

6. A method comprising:
determining a first adjustment range of a first scheduled occurrence of a first transmission event associated with a first data service based on a first transmission interval of the first data service and a non-zero first interval adjustment tolerance;
determining a second adjustment range of a second scheduled occurrence of a second transmission event associated with a second data service based on a second transmission interval of the second data service and a second interval adjustment tolerance;
determining, at a first wireless device, a first activation period based on an alignment of the first transmission event and the second transmission event in response to the first adjustment range and the second adjustment range being concurrent; and
activating a wireless interface of the first wireless device for the first activation period.

7. The method of claim 6, further comprising:
determining, at a second wireless device, a second activation period based on the alignment of the first transmission event and the second transmission event in response to the first adjustment range and the second adjustment range being concurrent; and
activating a wireless interface of the second wireless device for the second activation period, wherein the second activation period is concurrent with the first activation period.

8. The method of claim 6, wherein:
the second scheduled occurrence is concurrent with the first adjustment range; and
determining the alignment of the first transmission event and the second transmission event comprises adjusting the first transmission event to occur concurrently with the second scheduled occurrence.

9. The method of claim 8, wherein:
the second scheduled occurrence is subsequent to the first scheduled occurrence; and
adjusting the first transmission event comprises delaying the first transmission event.

10. The method of claim 8, wherein:
the second scheduled occurrence is prior to the first scheduled occurrence; and
adjusting the first transmission event comprises advancing the first transmission event.

11. The method of claim 6, wherein:
the second scheduled occurrence is subsequent to the first scheduled occurrence;
the second scheduled occurrence is not concurrent with the first adjustment range, the first scheduled occurrence is not concurrent with the second adjustment range, and the second adjustment range is a non-zero adjustment range; and
determining the alignment of the first transmission event and the second transmission comprises delaying the first transmission event to an identified time and advancing the second transmission event to the identified time, wherein the identified time is concurrent with both the first adjustment range and the second adjustment range.

12. The method of claim 6, further comprising:
transmitting an indicator of the first interval adjustment tolerance from the first wireless device for reception by a second wireless device.

13. The method of claim 12, wherein transmitting the indicator comprises transmitting a sleep request message for reception by the second wireless device, the sleep request message comprising the indicator.

14. The method of claim 6, further comprising:
conducting the first transmission event and the second transmission event at the first wireless device during the first activation period.

15. A method comprising:
determining a transmission interval associated with a data service and a non-zero interval adjustment tolerance for the transmission interval; and
transmitting an indicator of the interval adjustment tolerance from a first wireless device for reception by a second wireless device.

16. The method of claim 15, wherein transmitting the indicator comprises transmitting a sleep request message for reception by the second wireless device, the sleep request message comprising the indicator.

17. The method of claim 15, wherein the interval adjustment tolerance is based on a service type of the data service.

18. A device comprising:
a wireless interface;
a processing device coupled to the wireless interface; and
a memory coupled to the processing device, the memory configured to store a set of instructions configured to manipulate the processing device to:
determine a first adjustment range of a first scheduled occurrence of a first transmission event associated with a first data service based on a first transmission interval of the first data service and a non-zero first interval adjustment tolerance;
determine a second adjustment range of a second scheduled occurrence of a second transmission event associated with a second data service based on a second transmission interval of the second data service and a second interval adjustment tolerance;
determine an alignment of the first transmission event and the second transmission event in response to the first adjustment range and the second adjustment range being concurrent; and
activate the wireless interface for an activation period based on the alignment of the first transmission event and the second transmission event.

19. The device of claim 18, wherein the set of instructions are configured to manipulate the processing device to:
conduct the first transmission event and the second transmission event during the activation period.

20. The device of claim 18, wherein the set of instructions are configured to manipulate the processing device to:
provide an indicator of the first interval adjustment tolerance for transmission by the device for wireless reception by another device.
